(19) United States
(12) Patent Application Publication
(10) Pub. No.: US 2007/0257391 A1
(43) Pub. Date: Nov. 8, 2007

(54) Method for Manufacturing a Light Article of Conglomerate Material and Associated Composite Panel

(76) Inventor: Luca Toncelli, Bassano del Grappa (IT)

Correspondence Address: KATTEN MUCHIN ROSENMAN LLP, 575 MADISON AVENUE, NEW YORK, NY, 10022-2585, US

(21) Appl. No.: 11/596,155

(22) PCT Filed: May 10, 2005
(86) PCT No.: PCT/EP05/52073

§ 371 Date: Nov. 10, 2006

(30) Foreign Application Priority Data
May 18, 2004 (IT) TV2004A000057

(51) Int. Cl. C08J 9/32

(52) U.S. Cl. 264/45.5; 106/601

(57) ABSTRACT

Method for manufacturing light articles of conglomerate material in the form of slabs (10) or blocks, comprising a first step involving preparation of a mix composed of a granulate (12), a filler (14) and a hardening resin, a second step involving distribution of the mix thus formed inside a mould or formwork, a third step involving vacuum vibrocompression of the mix contained inside the mould or formwork and a fourth step involving hardening by means of catalysis of the hardening resin. The method also envisages the manufacture of composite panel (20) by combining light slab of conglomerate material (10) with a linibg sheet (22).

The present invention relates to a method for manufacturing a light article of conglomerate material using a technology—called Bretonstone technology—which is well known in the sector of agglomerate materials.

This technology involves various steps: during the initial step a mix composed mainly of a granulate of inert material, such as for example a granulate obtained from materials such as, for example, granite, marble or ceramic materials, is prepared and a filler, such as siliceous sand, and a hardening resin such as, for example, a polyester, epoxy, vinyl ester or acrylic resin, is added to said granulate.

The mix is then poured into a tray mould, if a slab is to be produced, or into a formwork, if a block is be produced, and subjected to vacuum vibrocompression in order to compact it.

The mould or formwork, containing respectively the compacted slab or the block, is transferred to a hardening station where it is hardened by means of catalysis of the resin, thus producing either a hardened slab or a hardened block.

In the case where a block is produced, the block then undergoes sawing in order to obtain in any case slabs of conglomerate material.

This complex technology, although well established, is continuously evolving and being improved and perfected in order to satisfy the increasingly demanding requirements of various applications.

One of the primary aims of this technology is to manage to obtain slabs of conglomerate material which are light, but which at the same time have sufficient mechanical strength and compactness characteristics such as to allow use of these slabs in widely varying sectors of the building and furniture industry.

In this connection various solutions have been proposed and developed, such as, for example, that described and claimed in Italian patent application No.

TV2003A000134 filed on 29 Sep. 2003, according to which in the abovementioned method an expanded material, such as, for example, expanded clay or foam glass, is used.

In one particular solution it is also envisaged using a reinforcement in the form of a web of continuous filaments arranged between two layers of mix, one of which is lightened owing to the use of expanded granulates.

Another example is that described in Italian patent No. 01316465 relating to a slab of conglomerate material obtained using expanded clay as the granulate, which slab is then enclosed between two layers of fibreglass matting impregnated with an epoxy resin.

The slabs obtained with this method described above have a low specific weight and excellent mechanical strength properties, since they contain reinforcing elements inside them.

It would be desirable, however, to manage to produce slabs of conglomerate material which ate extremely light, even slabs with a specific weight less than that of water, or less than 1 kg/dm³, having at the same time good mechanical properties and being sufficiently compact to have very low water absorption coefficients.

The advantages which would be obtained in this way are obvious.

In fact the slabs would be easy to process and transportation and laying thereof would be simple, thereby reducing all the costs of the processing operations, transportation and laying.

A slab produced in this way would have multiple uses, being able to be used in various areas of the building and furniture industry, ranging from wall cladding to formation of dividing walls, false ceilings and the like.

The object of the invention is therefore to provide a method for manufacturing articles of extremely light conglomerate material in the form of slabs or blocks as well to produce a very light composite panel having satisfactory mechanical properties and optimum aesthetic characteristics.

These objects are achieved with a method of the type already described, namely a method for manufacturing light articles of conglomerate material in the form of slabs or blocks, comprising a first step involving preparation of a mix composed of a granulate, a thin filler and a hardening resin, a second step involving distribution of the mix thus formed inside a mould or formwork, a third step involving vacuum vibrocompression of the mix contained inside the mould or formwork and a fourth step involving hardening by means of catalysis of the hardening resin, characterized in that said thin filler comprises granules of expanded material having a size of less than 0.15 mm.

A first advantageous feature of the slab produced with the method according to the present invention is that, owing to use of a filler composed of expanded granules, the weight of the final slab is reduced considerably.

In particular, if the granulate is also an expanded granulate, made with a material chosen for example from foam glass or expanded clay, the specific weight of the final slab is greatly reduced.

Another advantageous feature of the invention is that of allowing the light slab of conglomerate material to be combined with a lining sheet, such as a sheet of agglomerate stone material or other material, for example metallic material having coefficients of linear thermal expansion which are very similar to those of the light slab; in fact, in order to prevent the occurrence of distortion of the composite panel upon variation in the temperature, the two combined materials must have coefficients of linear thermal expansion which are neatly identical.

A composite panel which has notable aesthetic properties, but which at the same time is very light, is thus obtained.

These and further advantages will emerge more clearly from the following detailed description of an embodiment of the invention provided purely by way of a non-limiting example, with reference to the accompanying drawings in which:

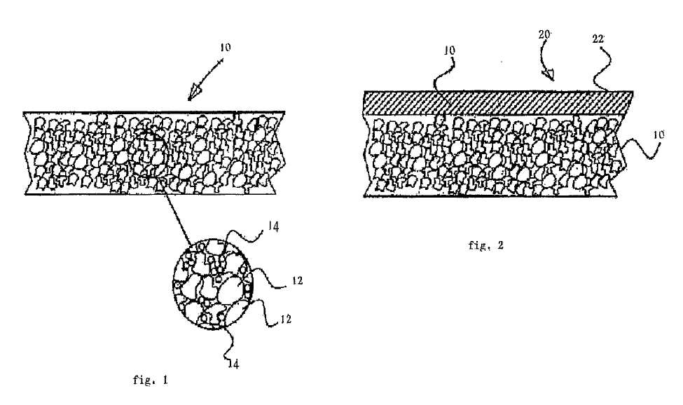

FIG. 1 is a cross-sectional view with an enlarged detail of a slab produced according to the method of the present invention; and

FIG. 2 is a cross-sectional view of a composite panel produced according to the method of the present invention.

In FIG. 1, 10 denotes overall a slab of conglomerate material.

The conglomerate slab 10 is obtained with the following method.

A mix is prepared by mixing together:

a granulate of inert material, which in the specific case is an expanded material such as expanded clay, or foam glass or other expanded inorganic materials such as alumina, having a grain size of between 0.15 mm and 6 mm;

a thin filler consisting of expanded granules with a grain size of less than 0.15 mm;

a hardening resin, in particular chosen from among polyester, epoxy, vinyl ester or acrylic resins;

any addition of other additives, such as accelerators or catalysts for catalysis of the resin.

Then the mix is poured in a uniform manner into a tray mould or into a formwork so as to form a layer of mix.

The material is then subjected to a vibro-compressive action in a vacuum environment so as to obtain a compacted article.

Finally the compacted article is hardened by means of catalysis of the resin, thus producing the desired final product

In particular, it is possible to use as fillers granules consisting of hollow silicate microspheres (e.g. fillite obtained from a selection of fly ash) with a specific weight of less than 0.7 kg/dm³ or granules consisting of an expanded igneous rock (e.g. rhyolite) with a specific weight of less than 0.40 kg/dm³ or also it is possible to use expanded granules formed with a thermoplastic polymer material having a specific weight of less than 0.05 kg/dm³.

In FIG. 1, which shows an enlarged detail of the cross-section relating to the internal structure of the conglomerate slab 10, the reference number 12 denotes the granulate, while the reference number 14 denotes the filler. It should be noted how the structure of the conglomerate slab 10 is substantially formed entirely by hollow elements and by a resinous binder (which is therefore fairly light), thus making it possible to obtain a material with a very low specific weight, of up to about 0.8 kg/dm³, so that it is similar to that of reconstituted wood panels and is therefore less than 1 kg/dm³, which is the specific weight of water.

An example of a possible composition is the following one in which the percentage refers to the volumetric composition of the mix:

| | |
|---|---|
| polyester resin | 20% |
| fillite | 20% |
| foam glass granulate (0.2-4.0 mm) | 60% |

From experimental tests carried out on an article obtained with the method described above and using the composition just mentioned, it was also found that the flexural strength is about 10-11 N/mm², a satisfactory value for practical uses, which allows the product to be used in many applications, as will be described below.

It was also found that the coefficient of linear thermal expansion of the resultant article is low; in fact, the measurement performed at 20° C. provided values of between 14 and 21×10⁻⁶ litres/° C. or between 14 and 21 μm (m° C. ) depending on the nature of the filler used.

These low values allow the slab obtained to be combined with many other materials of the composite stone type (conglomerates) or metallic materials, which have a similar coefficient of linear thermal expansion, thus obtaining composite panels, as will be illustrated below.

It is also worth noting another important characteristic of the product which arises precisely from its substantially hollow or cellular structure: in fact, owing to its cellular structure, such a slab forms an optimum heat insulator as well as a reasonable sound insulator. All these particular physical/mechanical properties mean that the slab is of great interest, in particular in the building and furnishing sectors.

With this slab it is in fact possible to form in an advantageous manner dividing walls and false ceilings for homes and offices, cladding for existing walls, etc. Owing to its low specific weight and its insulating power, it therefore constitutes a material which is ideal in the interior furnishings sector.

The same method may also be used for manufacturing blocks. In this case, instead of using a tray mould, a formwork is used, the mix being poured into it.

Once the hardened block is obtained following catalysis, the block undergoes sawing by means of frames, resulting in a plurality of lights slabs of conglomerate material.

Another very interesting application consists in upgrading of the light conglomerate slab thus obtained.

FIG. 2 shows, for example, a composite panel 20 which is obtained by combining the light conglomerate slab 10 with a lining sheet 22 made of high quality material. For example, the lining sheet 22 could be a sheet of agglomerate stone material having a coefficient of linear thermal expansion which is very similar.

Obviously the lining sheet 22 forms the visible surface of the composite panel 20.

In this embodiment the bond between the light conglomerate slab 10 and the lining sheet 22 is performed by means of gluing, preferably in vacuum conditions in order to prevent air bubbles in the interface, using suitable adhesives, such as for example epoxy resins or polyurethane resins.

Alternatively, if the lining sheet 22 is a sheet of agglomerate obtained from stone granulates (marbles, granites, etc.) which are bonded together using binders of an organic nature, such as hardening resins, (which sheet is therefore obtained with a method similar to that of the light conglomerate slab), it is possible to form the composite panel by means of a single vacuum vibro-compaction step and a single subsequent catalysis step.

In this case, after preparing a first mix necessary for the formation of the light conglomerate slab, a second mix for formation of the agglomerate lining sheet is prepared, a layer of the first mix is poured into a tray mould and another layer consisting of the second mix is poured on top of it.

The two layers of mix contained in the tray mould undergo vacuum vibrocompaction and then catalysis inside a catalysis oven in order to obtain then the composite panel 20; for this purpose, by suitably choosing both the type of binding resin and the catalyst, an identical catalysis reaction of the two layers is ensured, in order to avoid distortion of the article.

The agglomerate lining sheet 22 has a thickness normally of less than 10 mm, and preferably 5-6 mm, while the slab of conglomerate material 10 has a thickness normally of between 10 and 25 mm.

At the end a composite panel is obtained which is very light owing to the light conglomerate slab 10, but at the same time has optimum aesthetic/ornamental features provided by the lining sheet 22.

It is also possible to insert between the two layers of mix reinforcing elements in the form, for example, of filaments of fibre, for example glass or carbon fibres, resulting in a product which is reinforced and therefore very resistant to mechanical stresses.

Preferably the non-visible surface of the composite panel is sealed by means of application of a thin impermeable film, in order to prevent superficial absorption of moisture by the light layer and prevent possible deformation of the panel.

In this way it is possible to use the light conglomerate slab 10 in many other applications within the sector for cladding of walls or floors, both inside and outside, or for furniture such as tops for kitchens or baths, tables or the like.

It is also obvious that any variation or modification which is functionally or conceptually equivalent falls within the scope of protection of the present invention.

1. Method for manufacturing light articles of conglomerate material in the form of slabs (10) or blocks, comprising a first step involving preparation of a mix composed of a granulate (12), a thin filler (14) and a hardening resin, a second step involving distribution of the mix thus formed inside a mould or formwork, a third step involving vacuum vibrocompression of the mix contained inside the mould or formwork and a fourth step involving hardening by means of catalysis of the hardening resin, characterized in that said thin filler (14) comprises granules of expanded material.

2. Method according to claim 1, characterized in that said thin filler (14) of expanded material has a grain size of less than 0.15 mm.

3. Method according to claim 3, characterized in that said expanded granules of said filler (14) consist of hollow silicate microspheres.

4. Method according to claim 3, characterized in that said expanded granules of said filler (14) consist of an expanded igneous rock.

5. Method according to claim 3, characterized in that said expanded granules of said filler (14) are made of thermoplastic material.

6. Method according to claim 2, characterized in that said granulate (12) is an expanded granulate.

7. Method according to claim 6, characterized in that said granulate (12) is an expanded granulate with a grain size of between 0.2 mm and 6.0 mm.

8. Method according to claim 8, characterized in that said expanded granulate (12) is chosen from among foam glass, expanded clay or other expanded inorganic materials.

9. Method according to claim 1, characterized in that said hardening resin is chosen from among polyester, epoxy, acrylic or vinyl ester resins.

10. Method according to claim 1, characterized in that it comprises an additional step in which said slab of conglomerate material (10) is combined with a lining sheet (22), resulting in a light composite panel (20).

11. Method according to claim 10, characterized in that said bond between said slab of conglomerate material (10) and said lining sheet (22) is performed by means of gluing.

12. Method according to claim 11, characterized in that said gluing is performed by means of epoxy or polyurethane resins, preferably in vacuum conditions.

13. Method according to claim 1, characterized in that said mix is distributed inside a tray mould and said preparation step envisages the preparation of a second mix comprising stone or ceramic granules, a hardening resin and a filler, and said mix distribution step envisages also the distribution of said second mix inside said tray mould so as to form a second layer of mix, such as to obtain a light composite panel (20) composed of a light slab of conglomerate material (10) and a lining sheet (22).

14. Method according to claim 13, characterized in that reinforcing elements are inserted between said two layers of mix.

15. Method according to claim 10 or 13, characterized in that said lining sheet (22) has a thickness of less than 10 mm and said slab of conglomerate material (10) has a thickness of between 10 and 25 mm.

16. Method according to claim 10 or 13, characterized in that the non-visible surface of the composite panel is sealed by means of application of a thin impermeable film, in order to prevent superficial absorption of moisture by the light layer and prevent possible deformation of the panel.

17. Slab of conglomerate material (10) which can be obtained with the method according to claim 1.

18. Slab of conglomerate material (10) which can be obtained with the method according to any one of claims 2 to 16.

19. Composite panel (20) comprising a slab of agglomerate material (10) according to claim 17 and/or 18 combined with a lining sheet (22).
